(19) United States
(12) Patent Application Publication
(10) Pub. No.: US 2003/0103045 A1
(43) Pub. Date: Jun. 5, 2003

(54) Display device and driving method thereof

(75) Inventor: Tai Shiraishi, Yamatokoriyama-shi (JP)

Correspondence Address: EDWARDS & ANGELL, LLP, P.O. BOX 9169, BOSTON, MA, 02209, US

(73) Assignee: Sharp Kabushiki Kaisha

(21) Appl. No.: 10/282,833

(22) Filed: Oct. 29, 2002

(30) Foreign Application Priority Data
Oct. 30, 2001 (JP) 2001-332543
Jul. 2, 2002 (JP) 2002-193909

(51) Int. Cl. G09G 5/00

(52) U.S. Cl. 345/204

(57) ABSTRACT

A display device of the present invention is provided with (1) a plurality of gate lines and a plurality of source lines arranged in a matrix, (2) a standby line provided along a source line termination area arranged so as to cross the plurality of source lines where the standby line is connected to a burned-out source line having a burned-out point, (3) a source driver, which is provided on a source line terminal area side, including (a) a normal output section for supplying a display data signal to the source line, and (b) a compensating output section for supplying a display data signal to the compensating line, and (4) a control substrate for controlling the source driver so that the compensating output section outputs the data signal corresponding to the burned-out source line. With this, in the display device having an arrangement capable of compensating the burned-out source line, it is possible to miniaturize the display device with a smaller frame area by reducing the number of the standby lines, and to reduce degradation of a display quality by preventing a cross capacitance generated at an intersection of the compensating line and a source line on the signal input terminal area side.

### FIELD OF THE INVENTION

The present invention relates to a display device having a compensating line for a burned-out source line, and to a driving method thereof.

### BACKGROUND OF THE INVENTION

Conventionally, a liquid crystal display device, for example, in which a plurality of gate lines and a plurality of source lines (signal lines) are arranged in a matrix has an arrangement for compensating a burned-out source line, as disclosed in Japanese Unexamined Patent Publication No. 8-171081/1996 (Tokukaihei 8-171081, published on Jul. 2, 1996). The following will explain a liquid crystal module structure of the liquid crystal display device with reference to FIG. 3.

As shown in FIG. 3, the liquid crystal display device is provided with a liquid crystal panel 101, a source driver 102, a gate driver 103, a source substrate 104, a gate substrate 105, and a control substrate 106.

On the liquid crystal panel 101, a plurality of source lines 110 and a plurality of gate lines 111 are arranged in a matrix, and a pixel section 113 is arranged in a vicinity of each intersection of the plurality of source lines 110 and the plurality of gate lines 111. At each of the pixel sections 113, the source line 110 is connected to a pixel electrode 115 via a thin film transistor 114, whereas the gate line 111 is connected to a gate terminal of the thin film transistor 114. Further, at the pixel section 113, a counter electrode 116 is provided so as to face the pixel electrode 115, with sandwiching a liquid crystal layer.

On the liquid crystal panel 101, a source driver (source TAB (Tape Automated Bonding)) 102 is electrically connected to a terminal area 107 of the source line 110, whereas a gate driver (gate TAB) 103 is electrically connected to a terminal area 108 of the gate line (scanning line) 111. Further, the source driver 102 is electrically connected to the source substrate 104, whereas the gate driver 103 is electrically connected to the gate substrate 105. Further, the source substrate 104 is electrically connected to the control substrate 106 on which a controller 129 is mounted.

The controller 129 sends display data to each of the source drivers 102 via a data bus 117. In response to this, the source driver 102 sends a data signal to each of the source lines 110. On the other hand, the gate driver 103 sends a gate voltage to each of the gate lines 111 so as to switch ON the thin film transistor 114 which is provided at each of the pixel sections 113. Then, the data voltage output from the source driver 102 to the source line 110 is stored in a condenser (a capacitance formed at the liquid crystal layer). With these sequential operations, each pixel can store a desired voltage so as to perform desired display operations.

In the liquid crystal display device, when the source line 110 has a burned-out point 118, the source driver 102 cannot apply the source voltage to the pixel electrode 115 which is connected to the source line 110 on the termination section side with respect to the burned-out point 118. Namely, the pixel section 113 cannot be recharged with a desired voltage. Consequently, the pixel sections 113 on the lower side of the burned-out point 118 cannot operate, thus causing a line defect of the source line 110.

Therefore, the above-described liquid crystal display device can correct the line defect using standby lines 119 and 120. For this purpose, on the liquid crystal panel 101, a compensating line called as the standby line 119 is provided in the terminal area 107 of the source line 110, and the standby line 120 is provided in a termination area 109 of the source line 110. Namely, via the standby line 120, the output of the corresponding source driver 102 is routed through the source line 110 on the input terminal side (terminal section side) with respect to the burned-out point 118, the standby line 119, the source driver 102, the source substrate 104, the gate substrate 105, and the gate driver 103, so as to be supplied to the source line 110 on the termination section side with respect to the burned-out point 118. Note that, the standby lines 119 and 120 are connected to the source line 110 by carrying out short-circuit processing (usually fusion processing) with a projection of a laser beam.

More specifically, the output of the source driver 102 is routed through a normal output buffer 121 which is provided at the source driver 102, a connection point 122 of the source line 110 and the standby line 119, and the standby line 119, so as to be supplied to a compensating output buffer 123 which is provided at the source driver 102. After subjected to current amplification at the compensating output buffer 123, the signal is routed through a connecting line 124 on the source substrate 104, a connecting cable 125, the gate substrate 105, a flexible line 126 of the gate driver 103, the standby line 120, and a connection point 127 of the standby line 120 and the source line 110, so as to be supplied to the pixel section 113 on the termination section side of the corresponding source line 110 with respect to the burned-out point 118.

In other words, the above-described conventional liquid crystal display device compensates the burned-out source line 110 in a following manner; both sides of the source line 110 with respect to the burned-out point 118 are connected with each other via the compensating output buffer 123, using the standby line 119 on the input terminal section side of the source line 110 and the standby line 120 on the termination section side of the source line 110.

Note that, the compensating output buffer 123 is a buffer amplifier, which is provided at a source driver IC 128 in the source driver 102, for simply performing the current amplification to the source voltage received from an outside. Therefore, the compensating output buffer 123 does not have a function to generate the source voltage in itself. Further, the compensating output buffer 123 may be provided at the same chip or at a different chip of the source driver 102, but the compensating output buffer 123 is not dependent on and is not electrically connected to the controller 129.

In the above-described conventional arrangement, each of the source drivers 102 can correct usually one defective source line 110 using the standby lines 119 and 120. Accordingly, the standby lines 119 and 120 and the connecting line 124 between the standby lines 119 and 120 are respectively provided in the same number as the source drivers 102. The display device, which is provided with eight source drivers 102, for example, is provided with eight pairs of (respectively eight lines of) the standby lines 119 and 120 and the connecting line 124. In this case, the connecting lines 124 from each of the source drivers 102 are respectively wired via the source substrate 104 up to a connector (not shown) of the connecting cable 125 for the gate substrate 105, thus requiring the wiring in the same number as the source drivers 102. Consequently, a large number of the connecting lines 124 cross the source substrate 104, thereby increasing an area of the source substrate 104. As a result, a frame area (an area outside a display area) increases, thereby increasing outside dimensions of the display device.

Further, the standby line 119 needs to be provided in a vicinity of a connecting section of the source driver 102 at the terminal area 107 of the source line 110, in order to guide the output voltage to the compensating output buffer 123 so as to be supplied to the burned-out source line 110. Nevertheless, the terminal area 107 of the source line 110 needs to obtain an area for connection the source drivers 102. Thus, when newly providing the standby line 119 in a vicinity of the connecting area, the terminal area 107 of the source line 110 needs to be increased. This also increases the outside dimensions of the display device, or alternatively decreases an area of a display area 112.

Further, the standby line 119 crosses each of the source lines 110 which are respectively connected electrically to all of the output terminals (not shown) of one source driver 102. Note that, each source driver 102 usually has 300 through 500 output terminals.

The standby line 119 crosses these source lines 110 respectively at a right angle via an insulation layer. At each of the intersections, the source line 110 and the standby line 119 form a kind of condenser so as to generate a cross capacitance (floating capacitance), thereby increasing load capacitance of the standby line 119. Accordingly, the output of the source driver 102 is affected by an output of the other source driver 102 due to the coupling with the other source driver 102 through the cross capacitance. Further, an input signal that is supplied to the compensating output buffer 123 is superposed with the cross capacitance of the standby line 119 and the output to the other source line 110.

As a result, the output buffer of the source driver 102 that is connected to the standby line 119 has a larger load capacitance. Further, when the source line 110 burns out at the terminal area 107 of the source line 110, strong influence of the load capacitance lowers a display quality (that is, the output voltage is not precise).

Further, each source driver usually can correct only one defective source line 110 for the above-described reason, for example; the standby line 119 needs to be provided in a vicinity of the connecting section of the source driver 102 at the terminal area 107 of the source line 110. Accordingly, when two or more source lines burn out among the plurality of source lines 110 that are driven by one source driver, it is impossible to correct all of the line defects.

### SUMMARY OF THE INVENTION

The object of the present invention is to provide a display device capable of being smaller in size with a smaller frame area by reducing the number of compensating lines as standby lines and capable of reducing degradation of a display quality by preventing a cross capacitance generated at an intersection of the compensating line and a source line on a signal input terminal section side, and a driving method thereof.

In order to attain the foregoing object, a display device of the present invention is characterized by including (1) a plurality of gate lines and a plurality of source lines arranged in a matrix, (2) a compensating line provided along a termination section on an opposite side of a signal input terminal section of the plurality of source lines, arranged so as to cross the plurality of source lines, (3) a source driver, which is provided on the signal input terminal section side of the plurality of source lines, including (a) a normal output section for supplying a display data signal to the source line, and (b) a compensating output section for supplying a display data signal to the compensating line, and (4) control means for controlling the source driver so that the compensating output section outputs the data signal corresponding to a burned-out source line.

With this arrangement, when the source line burns out, the burned-out source line on the termination section side with respect to the burned-out point is electrically connected to the compensating line at an intersection, for example, by projecting a laser beam.

In this condition, the normal output section of the source driver sends the display data signal to the signal input terminal section of the respective source lines. In this case, the data signal is not supplied to the burned-out source line on the termination section side with respect to the burned-out point. Thus, in response to the controller, the compensating output section of the source driver outputs a data signal corresponding to the burned-out source line (a data signal to be supplied originally from the signal input terminal section side), and the data signal is supplied to the termination side portion of the burned-out source line via the compensating line. This enables the display device to display images in a good condition in spite of the burned-out source line. Note that, at least only one compensating output section is required per source driver.

As described above, in the arrangement of the present invention, the compensating line for supplying the data signal to the burned-out source line is provided on the termination section side of the source line, but is not required on the signal input terminal section side. Therefore, it is possible to reduce a frame area required for providing the compensating line, thereby reducing a size of the display device.

Further, the compensating line is not required on the signal input terminal section side of the source lines, so as not to generate a cross capacitance at an intersection of the respective source lines and the compensating line on the signal input terminal section side of the source lines. This reduces deterioration of the compensating output (data signal) of the compensating line due to delay and deflection of the compensating output caused by the cross capacitance, thereby reducing the degradation of the display quality.

A driving method of a display device of the present invention, using a display device including (a) a plurality of gate lines and a plurality of source lines arranged in a matrix, and (b) a compensating line provided along a termination section on an opposite side of a signal input terminal section of the plurality of source lines, arranged so as to cross the plurality of source lines where the compensating line is connected to a burned-out source line having a burned-out point, the driving method of the display device, is characterized by including the steps of supplying a normal display data signal to respective signal input terminal sections of each of the plurality of source lines, and supplying a data signal corresponding to the burned-out source line, to the compensating line connected to the burned-out source line, in response to address information for specifying the burned-out source line.

With this arrangement, when the source line burns out, the burned-out source line on the termination section side with respect to the burned-out point is electrically connected to the compensating line at an intersection, for example, by projecting a laser beam.

In this condition, the display data signal is inputted to the signal input terminal section of the respective source lines. In this case, the data signal is not supplied to the burned-out source line on the termination section side with respect to the burned-out point. Thus, in response to the address information for specifying the burned-out source line, the data signal corresponding to the burned-out source line (a data signal to be supplied originally from the signal input terminal section side) is supplied to the termination side portion of the burned-out source line via the compensating line. This enables the display device to display images in a good condition in spite of the burned-out source line.

As described above, in the arrangement of the present invention, the compensating line for supplying the data signal to the burned-out source line is provided on the termination section side of the source line, but is not required on the signal input terminal section side. Therefore, it is possible to reduce a frame area required for providing the compensating line, thereby reducing a size of the display device.

Further, the compensating line is not required on the signal input terminal section side of the source lines, so as not to generate a cross capacitance at an intersection of the respective source lines and the compensating line on the signal input terminal section side of the source line. This reduces deterioration of the compensating output (data signal) of the compensating line due to delay and deflection of the compensating output caused by the cross capacitance, thereby reducing the degradation of the display quality.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram of a liquid crystal display device in accordance with an embodiment of the present invention.

FIG. 2(a) is a block diagram showing an arrangement of a controller shown in FIG. 1. FIG. 2(b) is a timing chart of signals of respective sections in the controller shown in FIG. 2(a).

FIG. 3 is a block diagram of a conventional liquid crystal display device.

FIG. 4 is a block diagram of a liquid crystal display device in accordance with another embodiment of the present invention.

FIG. 5 is a block diagram of a liquid crystal display device in accordance with a further embodiment of the present invention.

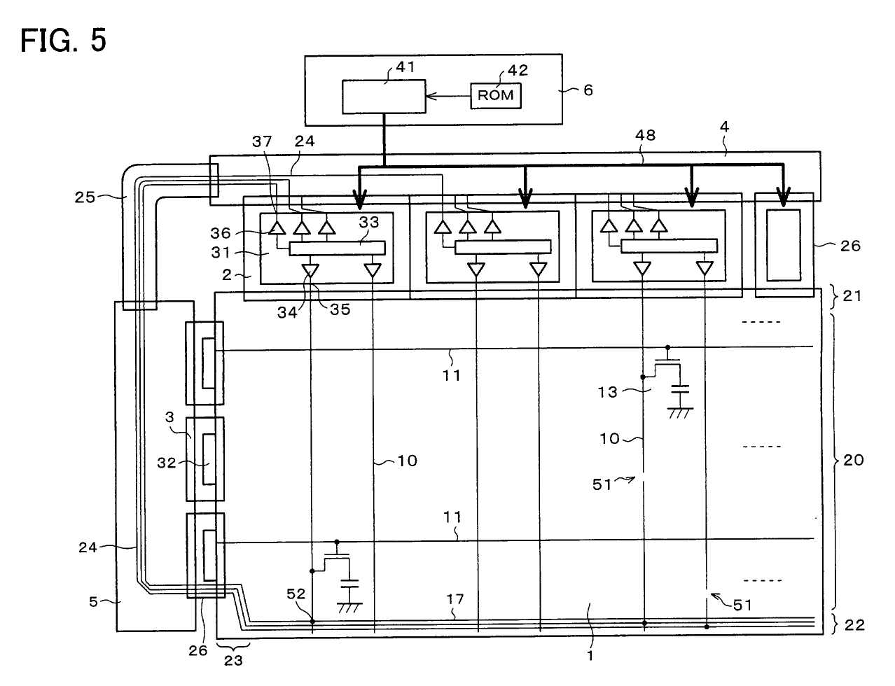

### DESCRIPTION OF THE EMBODIMENTS

[First Embodiment]

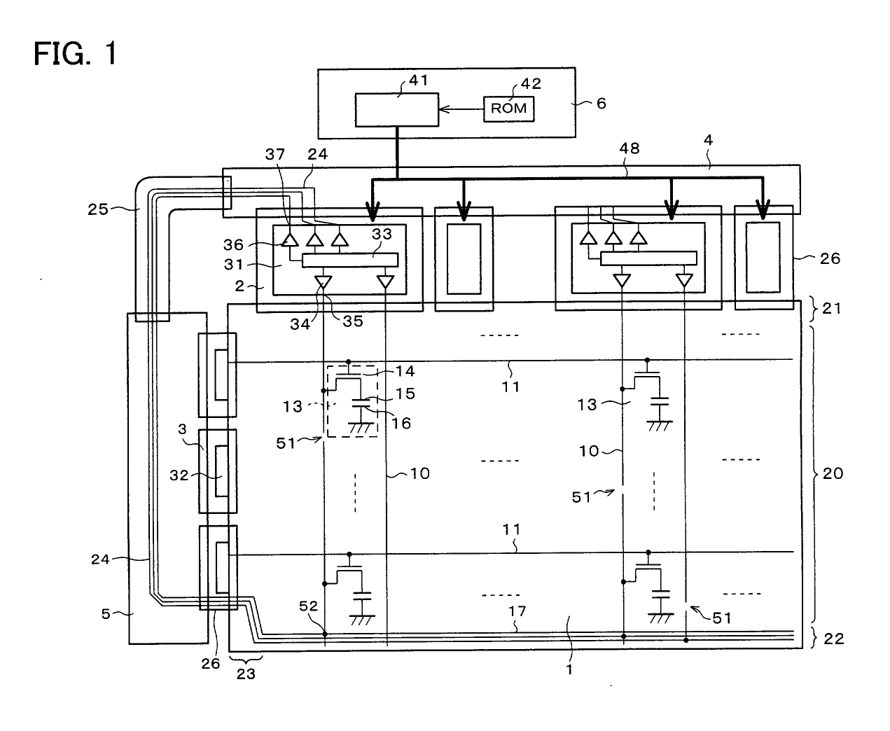

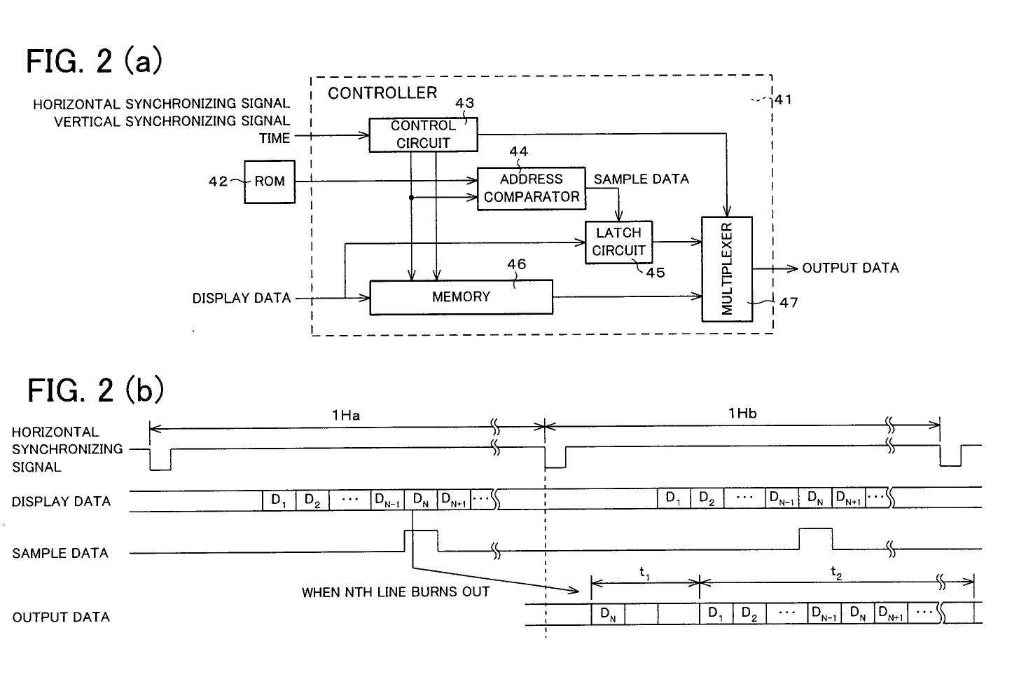

The following will explain an embodiment of the present invention with reference to FIGS. 1, 2(a) and 2 (b).

In the present embodiment, a display device is applied to a liquid crystal display device. As shown in FIG. 1, the liquid crystal display device is provided with a liquid crystal panel 1, a plurality of source drivers 2, a plurality of gate drivers 3, a source substrate 4, a gate substrate 5, and a control substrate 6.

On the liquid crystal panel 1, a plurality of source lines 10 and a plurality of gate lines 11 are arranged in a matrix, and a pixel section 13 is arranged in a vicinity of each intersection of the plurality of source lines 10 and the plurality of gate lines 11. At each of the pixel sections 13, the source line 10 is connected to a pixel electrode 15 via a thin film transistor 14, whereas the gate line 11 is connected to a gate terminal of the thin film transistor 14. Further, at the pixel section 13, a counter electrode 16 is provided so as to face the pixel electrode 15, with sandwiching a liquid crystal layer.

The source line 10 is composed of Al/Ti, whereas the gate line 11 is composed of TiN/Al/Ti. The source line 10 and the gate line 11 cross each other via an insulation film composed of silicon nitride film. The pixel electrode 15 is composed of transparent conductive film such as ITO (Indium Tin Oxide).

The liquid crystal panel 1 is provided with a source line terminal area 21 at a peripheral section of a display area 20 on one side, and a source line termination area 22 at a peripheral section of the display area 20 on the opposite side. The liquid crystal panel 1 is further provided with a gate line terminal area 23 at a peripheral section on the other side different from the above-mentioned two opposed sides. The source line terminal area 21 is provided with an input terminal (not shown) for applying a source voltage to the source line 10. The source line termination area 22 is provided with a standby line 17. The gate line terminal area 23 is provided with an input terminal (not shown) for applying a gate voltage to the gate line 11. The standby line 17 is provided at the source line termination area 22, so as to run parallel to the gate line 11 and to cross each of the source lines 10.

The input terminals of the source line 10 and of the gate line 11 are formed with a layered pattern of ITO/TiN/Al/Ti. The standby line 17 is composed of layered film formed with a layered pattern of TiN/Al/Ti.

On the liquid crystal panel 1, the source line terminal area 21 is electrically connected to a source driver (source TAB) 2 which is a drive circuit of the source line 10, whereas the terminal area 23 of the gate line (scanning line) 11 is electrically connected to the gate driver (gate TAB) 3 which is a drive circuit of the gate line 11. Further, the source driver 2 is electrically connected to the source substrate 4, whereas the gate driver 3 is electrically connected to the gate substrate 5. Further, the source substrate 4 is electrically connected to the control substrate 6.

The source substrate 4 and the gate substrate 5 are respectively provided with a plurality of connecting lines 24, and the connecting lines 24 of the source substrate 4 and the connecting lines 24 of the gate substrate 5 are electrically connected via a connecting cable 25. Further, the connecting lines 24 of the gate substrate 5 are electrically connected to the standby line 17 of the liquid crystal panel 1. Namely, a compensating line of the liquid crystal display device is composed of the connecting lines 24 of the source substrate 4, the connecting cable 25, the connecting lines 24 of the gate substrate 5, and the standby line 17.

Here, the source substrate 4 is connected with the source line 10 of the liquid crystal panel 1 via a flexible wiring substrate 26 at which the source driver 2 is provided. Similarly, the gate substrate 5 is connected with the gate line 11 of the liquid crystal panel 1 via the flexible wiring substrate 26 at which the gate driver 3 is provided. Specifically, the flexible wiring substrate 26 is respectively connected to the source line 10 and the gate line 11 via ACF (Anisotropic Conductor Film). Further, the gate driver 3 is connected to the gate substrate 5, and the source driver 2 is connected to the source substrate 4, respectively via the ACF.

The source driver 2 is composed of a source driver IC 31, whereas the gate driver 3 is composed of a gate driver IC 32. The source driver 2 is provided with a circuit section 33, a plurality of normal output buffers 34 connected to the circuit section 33, a normal output section 35 which is an output section of the normal output buffer 34, at least one (in the present embodiment, a plurality of) compensating output buffer 36 connected to the circuit section 33, and a compensating output section 37 which is an output section of the respective compensating output buffers 36.

The normal output buffers 34 are respectively connected to the source line 10, and the compensating output buffers 36 are respectively connected to the connecting lines 24 of the source substrate 4, namely to the standby line 17 of the liquid crystal panel 1. The normal output section 35 outputs a data signal corresponding to the normal source line 10, namely a normal output, whereas the compensating output section 37 outputs a data signal corresponding to the burned-out source line 10, namely a compensating output.

The control substrate 6 is provided with a controller 41 for controlling the source driver 2, and a ROM 42. The controller 41 is provided with a control circuit 43, an address comparator 44, a latch circuit 45, a memory 46, and a multiplexer 47, as shown in FIG. 2(a).

The control circuit 43 controls the memory 46 so that the address is written into and read out from the memory 46, and controls the multiplexer 47. The address comparator 44 performs operations for taking out display data in accordance with a burned-out line address which is stored in the ROM 42. The latch circuit 45 stores the display data which have been taken out by the address comparator 44. The memory 46 stores normal output data as the display data, which are supplied to the controller 41 from an outside of the liquid crystal display device. The multiplexer 47 is a circuit for outputting the compensating output data as the display data for the burned-out line which are stored in the latch circuit 45, by switching an output period from a readout period of the normal output data stored in the memory 46.

In the above arrangement, the controller 41 sends display data to each of the source drivers 2 via a data bus 48. In response to this, the source driver 2 sends a data signal to each of the source lines 10. On the other hand, the gate driver 3 sequentially sends a gate voltage to each of the gate lines 11 so as to sequentially switch ON the thin film transistor 14 which is provided at each of the pixel sections 13. The data voltage output from the source driver 2 to the source line 10 is stored in a condenser (a capacitance formed at the liquid crystal layer). With these sequential operations, each pixel section 13 can store a desired voltage so as to perform desired display operations.

Next, the following will explain operations of the liquid crystal display device, including operations of the controller 41 for generating the compensating output, with reference to FIGS. 2(a) and 2(b). Here, it is assumed that the nth source line 10 burns out. Note that, FIG. 2(b) is a timing chart showing respective data output.

First, the display data, which are supplied to the controller 41 from the outside of the liquid crystal display device, are once stored in the memory 46. The memory 46 usually has a capacity to store data of one horizontal scanning period (1Ha), and is used for sorting the display data, etc. The display data are sorted mainly by a kind of serial-parallel conversion, in order to reduce output frequency, and in order to output the sorted display data simultaneously to the plurality of source drivers 2.

The ROM 42 is a rewritable nonvolatile memory for simply storing burned-out line data (including the burned-out line address). The write address into the memory 46 correlates with source line numbers which are sequentially assigned from an edge of the liquid crystal display screen in the liquid crystal panel 1. In other words, by monitoring the write address into the memory 46, the write data of a particular source line 10 can be specified.

The address comparator 44 retrieves the data stored in the memory 46, in accordance with the burned-out line address stored in the ROM 42. The retrieved sample data are stored in the latch circuit 45.

With these sequential operations, the latch circuit 45 stores the compensating output data of the burned-out line for an amount to be acquired in one horizontal scanning period (1Ha). The compensating output data are outputted in a next horizontal scanning period (1Hb) in such a manner that the multiplexer 47 switches an output period to a compensating output period (t1) distinct from a readout period (t2) of the normal output data (stored in the memory 46). Note that, using the same format as the normal output, the compensating output is processed as additional output of the source driver 2.

For example, when each source driver 2 has 480 outputs, the source driver 2 is arranged to have a total of 484 outputs when four compensating output sections 37 are provided.

In the display device in FIG. 1, the compensating output data for the burned-out line, which are outputted from the controller 41 together with the normal output data for the source line 10, are transmitted to each of the source drivers 2 via the data bus 48 in a normal method. The transmitted data are converted into either the compensating output or the normal output at the circuit section 33.

The normal output is supplied to the source line 10 via the normal output section 35. Further, the compensating output is outputted from the compensating output section 37 in an endmost source driver 2 among the source drivers 2 in their aligned direction, for example.

When the source line 10 burns out at the burned-out point 51, the source line 10 and the standby line 17 are fused at the connection point 52 by projecting the laser beam. Then, the normal output section 35 outputs the normal output to the source line 10 on the source line terminal area 21 side (on the input terminal side) with respect to the burned-out point 51. On the other hand, the compensating output section 37 outputs the compensating output to the source line 10 on the source line termination area 22 side with respect to the burned-out point 51. In this case, the compensating output, which is outputted from the compensating output section 37, is supplied to the source line 10 on the source line termination area 22 side with respect to the burned-out point 51, after sequentially routed through the source substrate 4, the connecting cable 25, the gate substrate 5, the gate driver 3, the standby line 17 of the liquid crystal panel 1, and the connection point 52.

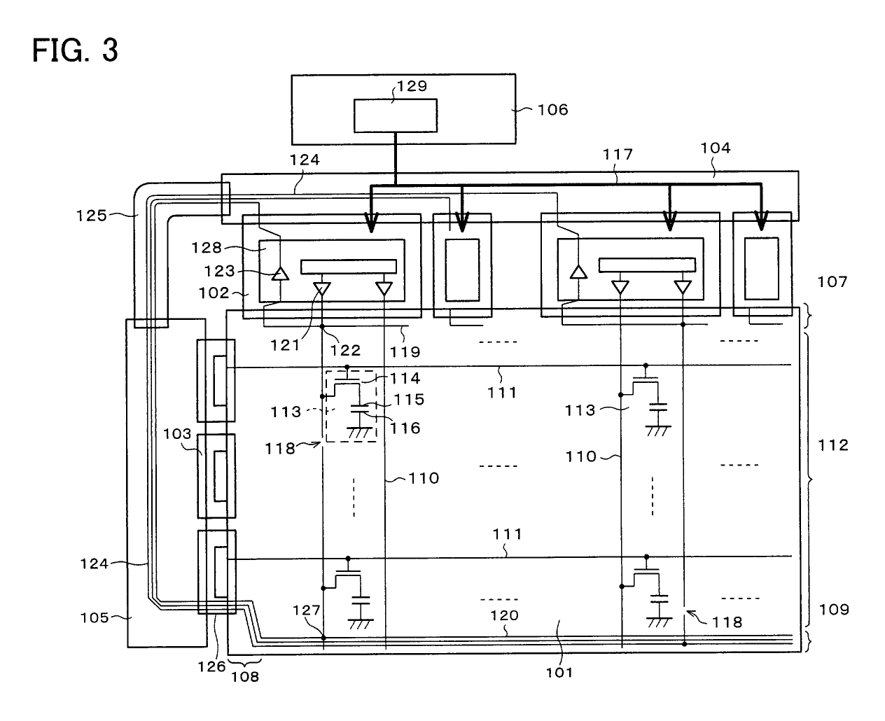

According to the present invention, the burned-out source line 10 is compensated as described above, it is therefore possible to omit the standby line 119 which was conventionally required at the source line terminal area 21 in the conventional liquid crystal display device as shown in FIG. 3. This reduces an area for the source line terminal area 21, thereby reducing the frame area of the liquid crystal display device.

Further, on the source line terminal area 21 side, the cross capacitance is not formed at an intersection of the standby line and the source line 10. This prevents the delay and deflection of the compensating output, thereby improving the display quality.

Further, on the source line terminal area 21 side, the standby line and the source line 10 are not required to be short-circuited with each other using means such as laser fusion. This prevents deterioration of the output voltage (the compensating output) due to the connection of the standby line. This also reduces a step such as the laser fusion, thereby reducing a manufacturing cost.

Further, one source driver 2 can be easily provided with a plurality of the compensating output sections 37 for supplying the compensating output, for the reason that the standby line is not required on the source line terminal area 21 side, and for other reasons. Accordingly, it is possible to supply the compensating output to a plurality of burned-out source lines 10 using only one endmost source driver 2 among the plurality of source drivers 2 arranged on the liquid crystal panel 1. In this case, the compensating output sections 37 of the other source drivers 2 are not used, thus turning to open states.

Therefore, the burned-out line does not need to be supplied with the compensating output only from the source driver 2 which was originally required to drive the burned-out source line 10 in the conventional arrangement. This shortens the length of the connecting line 24 to be arranged on the source substrate 4, and prevents the signal delay and the signal deflection of the compensating output due to the arrangement of the connecting line 24.

Further, one source driver 2 is provided with the plurality of the compensating output sections 37 for supplying the compensating output. Accordingly, when a plurality of source lines 10 burn out on the liquid crystal panel 1, by using the compensating output section 37, it is not required to arrange each of the connecting lines 24 up to the source driver 2 which was originally required to drive the burned-out source line 10. This enables the respective connecting lines 24 to have an approximately equal length for arrangement, thereby preventing the degradation of the display quality caused by differences in the arranged length. Incidentally, the respective driving power of the plurality of compensating output buffers 35 provided in the source driver 2 may be the same, or may be different in accordance with the respective distances from the respective connecting lines to the respective burned-out lines.

Further, when increasing the number of the source lines 10 to be compensated, or reducing the number of the compensating output section 37 provided to one source driver 2, the compensating output sections 37 may be sequentially used from the endmost source driver 2.

Further, when the source line 10 burns out in a block of the source lines 10 where the normal output is supplied from the source driver 2 other than the endmost source driver 2, the controller 41 allows the endmost source driver 2 to output the data, which are to be supplied from the other source driver 2, to the burned-out line as the compensating output data. With this, it is possible to use the compensating output of the source driver 2 other than the source driver 2 of the source line having the burned-out point, thereby removing restrictions on the number of burned-out points for one source driver 2 to compensate.

[Second Embodiment]

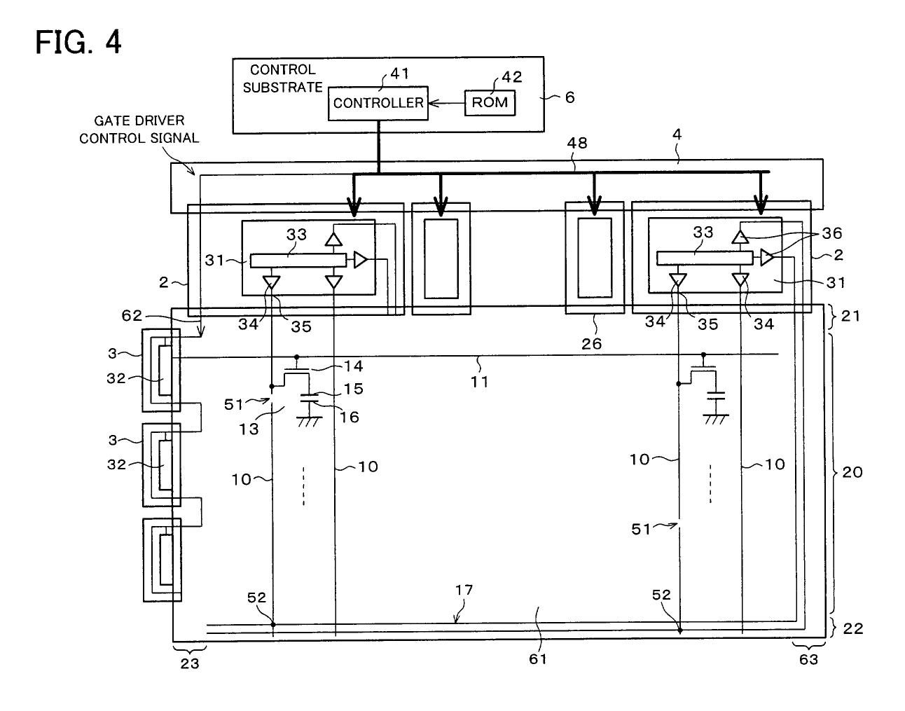

The following will explain another embodiment of the present invention with reference to FIG. 4. Note that, for ease of explanation, members having the same functions as those shown in the first embodiment will be given the same reference symbols, and explanation thereof will be omitted here.

The display device of the present embodiment has a gate substrate omitted structure. In the gate substrate omitted structure, the gate substrate 5 is removed by adapting an arrangement wherein the gate control signal from the controller 41 is supplied to each of the gate drivers (gate TAB) 3 via the source driver (source TAB) 2 and an on-panel wiring section 62. In accordance with the adaptation of the gate substrate omitted structure, the standby line 17 is arranged on a peripheral section of a display area of the display panel 61 in the display device of the present embodiment.

In this case, the standby line 17 may be wired through the same route as the above-described lines for supplying the gate control signal, but in the present display device, the standby line 17 is wired through a gate line non-formed area 63 where the gate line 11 is not formed, which is an edge section opposite to the edge section on the gate driver 3 side in the liquid crystal panel 61. Namely, the standby line 17 is arranged along the gate line non-formed area 63 and the source line termination area 22, both of which are edge sections in the liquid crystal panel 61 on the sides where neither the gate driver 3 nor the source driver 2 is provided, so that the standby line 17 does not cross the gate line 11.

Note that, the liquid crystal panel 61 has basically the same arrangement as the liquid crystal panel 1, except that the on-panel wiring section 62 is provided, and the standby line 17 is formed along the gate line non-formed area 63 and the source line termination area 22.

Further, the standby line 17 is connected to the compensating buffer 36 in an endmost source driver 2 among the source drivers 2 arranged along the source line terminal area 21, which is on the side of the gate line non-formed area 63, namely on the side of the input terminal of the standby line 17 (a rightmost source driver 2 in FIG. 4).

In the above arrangement, an output signal is outputted from the compensating output buffer 36 to the standby line 17 without routed through the source substrate 4. The output signal is then supplied to the source line 10 having the burned-out point 51, via the standby line 17 which is routed through the gate line non-formed area 63 on the edge section opposite to the edge section on the gate driver 3 side, the source line termination area 22 on the edge section opposite to the edge section on the source driver 2 side, and the connection point 52.

In the above-described arrangement, even when the display device has a gate substrate omitted structure, the standby line 17 can be arranged so as not to cross the gate line 11. Therefore, it is possible to prevent the increase of the load capacitance caused when the standby line 17 crosses the gate line 11. Further, by widening the standby line 17 so as to lower its impedance, the above arrangement can be applied to an arrangement for reducing signal deterioration. Note that, other functions are the same as in the display device in accordance with the first embodiment.

As described above, a display device of the present invention is arranged so as to include (1) a plurality of gate lines and a plurality of source lines arranged in a matrix, (2) a compensating line provided along a termination section on an opposite side of a signal input terminal section of the plurality of source lines, arranged so as to cross the plurality of source lines where the compensating line is connected to a burned-out source line having a burned-out point, (3) a gate driver, which is provided on the signal input terminal section side of the plurality of gate lines, for supplying a scanning signal to the gate lines, (4) a source driver, which is provided on the signal input terminal section side of the plurality of source lines, including (a) a normal output section for supplying a display data signal to the source line, and (b) a compensating output section for supplying a display data signal to the compensating line, and (5) control means for controlling the source driver so that the compensating output section outputs the data signal corresponding to the burned-out source line.

As described above, a display device of the present invention is characterized by including (1) a plurality of gate lines and a plurality of source lines arranged in a matrix, (2) a compensating line provided along a termination section on an opposite side of a signal input terminal section of the plurality of source lines, arranged so as to cross the plurality of source lines, (3) a source driver, which is provided on the signal input terminal section side of the plurality of source lines, including (a) a normal output section for supplying a display data signal to the source line, and (b) a compensating output section for supplying a display data signal to the compensating line, and (4) control means for controlling the source driver so that the compensating output section outputs the data signal corresponding to a burned-out source line.

With this arrangement, when the source line burns out, the burned-out source line on the termination section side with respect to the burned-out point is electrically connected to the compensating line at an intersection, for example, by projecting a laser beam.

In this condition, the normal output section of the source driver sends the display data signal to the signal input terminal section of the respective source lines. In this case, the data signal is not supplied to the burned-out source line on the termination section side with respect to the burned-out point. Thus, in response to the controller, the compensating output section of the source driver outputs a data signal corresponding to the burned-out source line (a data signal to be supplied originally from the signal input terminal section side), and the data signal is supplied to the termination side portion of the burned-out source line via the compensating line. This enables the display device to display images in a good condition in spite of the burned-out source line. Note that, at least only one compensating output section is required per source driver.

As described above, in the arrangement of the present invention, the compensating line for supplying the data signal to the burned-out source line is provided on the termination section side of the source line, but is not required on the signal input terminal section side. Therefore, it is possible to reduce a frame area required for providing the compensating line, thereby reducing a size of the display device.

Further, the compensating line is not required on the signal input terminal section side of the source lines, so as not to generate a cross capacitance at an intersection of the respective source lines and the compensating line on the signal input terminal section side of the source lines. This reduces deterioration of the compensating output (data signal) of the compensating line due to delay and deflection of the compensating output caused by the cross capacitance, thereby reducing the degradation of the display quality.

The display device of the present invention may be so arranged that the control means includes a storing section for storing address information for specifying the burned-out source line.

With this arrangement, the control means can properly controls the source driver so that the compensating output section outputs a data signal corresponding to the burned-out source line in accordance with the address information stored in the storing section.

The display device of the present invention, provided with a display panel at least including the plurality of gate lines, the plurality of source lines, and the compensating line, may be so arranged that a plurality of the source drivers are arranged along an edge section of the display panel, and the compensating line is connected only to the compensating output section in an endmost source driver among the plurality of arranged source drivers.

With this arrangement, the compensating line is not required to be provided on the signal input terminal section side of the source line, so that the source driver can be easily provided with a plurality of compensating output sections for supplying the data signal to the compensating line. Thus, it is possible to arrange the compensating line to be connected only to the compensating output section of the endmost source driver.

According to the arrangement, the burned-out line does not need to be supplied with the compensating output only from the source driver which was originally required to drive the burned-out source line. This shortens the length of the compensating line to be arranged, and prevents the signal delay and the signal deflection of the compensating output due to the arrangement of the compensating line.

Further, when the endmost source driver is provided with the plurality of compensating output sections, and the plurality of source lines are compensated using the plurality of compensating lines connected to the plurality of compensating output sections, the respective compensating lines can have an approximately equal length for arrangement, thereby preventing the degradation of the display quality caused by differences in the arranged length.

The display device of the present invention, provided with a display panel at least including the plurality of gate lines, the plurality of source lines, and the compensating line, may be so arranged that a plurality of the source drivers are arranged along an edge section of the display panel, and the compensating line is connected only to a plurality of source drivers in a smaller number than a total number of the source drivers sequentially from an endmost source driver among the plurality of arranged source drivers.

With this arrangement, the compensating line is connected only to a plurality of source drivers sequentially from the endmost source driver among the plurality of arranged source drivers. With this, when the number of compensating output sections in the endmost source driver is smaller than the number of burned-out source lines, the remained burned-out source lines can be compensated by further using the compensating output section of a second source driver from the end source driver, for example.

Further, also in this case, used is the compensating output section of the source driver on the endmost side of the arranged source lines. This shortens the length of the compensating line to be arranged, and also prevents the signal delay and the signal deflection of the compensating output due to the arrangement.

The display device of the present invention may be so arranged that each source driver includes a plurality of the compensating output sections, and the compensating lines provided at least in a same number as the plurality of compensating output sections.

With this arrangement, the compensating output section of one source driver can compensate a plurality of the burned-out source lines.

The display device of the present invention, provided with a display panel at least including the plurality of gate lines, the plurality of source lines, and the compensating line, may be so arranged that the compensating line includes (a) a section extending in a direction of crossing the gate line and (b) a section extending in a direction of crossing the source line, which are respectively formed along an edge section of the display panel.

With this arrangement, the compensating line includes (a) a section extending in a direction of crossing the gate line and (b) a section extending in a direction of crossing the source line, which are respectively formed along an edge section of the display panel. The arrangement thus can be applied to a display device having a gate substrate omitted structure in which a gate substrate for including the gate driver is removed.

The display device of the present invention is so arranged that the compensating line includes the section extending in the direction of crossing the gate line, arranged so as not to cross the gate line in a gate line non-formed area, and the section extending in the direction of crossing the source line, arranged so as to cross the source line in the source line termination area.

With the arrangement, even when the display device has the gate substrate omitted structure, the compensating line includes the section extending in the direction of crossing the gate line, arranged so as not to cross the gate line in the gate line non-formed area, thereby preventing an increase in the load capacitance caused by the crossing of the compensating line and the gate line. Further, the compensating line is thickened so as to lower the impedance, so that the arrangement can reduce the signal deterioration.

A driving method of a display device of the present invention, using a display device including (a) a plurality of gate lines and a plurality of source lines arranged in a matrix, and (b) a compensating line provided along a termination section on an opposite side of a signal input terminal section of the plurality of source lines, arranged so as to cross the plurality of source lines where the compensating line is connected to a burned-out source line having a burned-out point, the driving method of the display device is characterized by including the steps of supplying a normal display data signal to respective signal input terminal sections of each of the plurality of source lines, and supplying a data signal corresponding to the burned-out source line, to the compensating line connected to the burned-out source line, in response to address information for specifying the burned-out source line.

With this arrangement, when the source line burns out, the burned-out source line on the termination section side with respect to the burned-out point is electrically connected to the compensating line at an intersection, for example, by projecting a laser beam.

In this condition, the display data signal is inputted to the signal input terminal section of the respective source lines. In this case, the data signal is not supplied to the burned-out source line on the termination section side with respect to the burned-out point. Thus, in response to the address information for specifying the burned-out source line, the data signal corresponding to the burned-out source line (a data signal to be supplied originally from the signal input terminal section side) is supplied to the termination side portion of the burned-out source line via the compensating line. This enables the display device to display images in a good condition in spite of the burned-out source line.

As described above, in the arrangement of the present invention, the compensating line for supplying the data signal to the burned-out source line is provided on the termination section side of the source line, but is not required on the signal input terminal section side. Therefore, it is possible to reduce a frame area required for providing the compensating line, thereby reducing a size of the display device.

Further, the compensating line is not required on the signal input terminal section side of the source lines, so as not to generate a cross capacitance at an intersection of the respective source lines and the compensating line on the signal input terminal section side of the source line. This reduces deterioration of the compensating output (data signal) of the compensating line due to delay and deflection of the compensating output caused by the cross capacitance, thereby reducing the degradation of the display quality.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A display device, comprising:
a plurality of gate lines and a plurality of source lines arranged in a matrix;
a compensating line provided along a termination section on an opposite side of a signal input terminal section of said plurality of source lines, arranged so as to cross said plurality of source lines;
a source driver, which is provided on the signal input terminal section side of said plurality of source lines, including (a) a normal output section for supplying a display data signal to said source line, and (b) a compensating output section for supplying a display data signal to said compensating line; and
control means for controlling said source driver so that said compensating output section outputs the data signal corresponding to a burned-out source line.

2. The display device as set forth in claim 1, wherein:
said control means includes a storing section for storing address information for specifying said burned-out source line.

3. The display device as set forth in claim 1, wherein:
said control means outputs (a) normal output data sent from said normal output section and (b) compensating output data sent from said compensating output section to each of said plurality of source drivers.

4. The display device as set forth in claim 2, wherein:
said control means (a) outputs normal output data sent from said normal output section to each of said plurality of source drivers, and (b) outputs display data corresponding to the address information stored in the storing section to each of said plurality of source drivers as compensating output data sent from said compensating output section.

5. The display device as set forth in claim 4, wherein:
said control means outputs the compensating output data to each of said plurality of source drivers, by switching an output period to a period distinct from a readout period of the normal output data.

6. The display device as set forth in claim 5, wherein said control means includes:
an address comparing section for outputting sample data when the sample data correspond to the address information stored in the storing section;
a latch circuit section for latching the display data as the compensating output data, in accordance with the sample data;
a normal output data memory for storing the normal output data, and
a multiplexer for outputting the compensating output data latched in the latch circuit section, by switching the output period to the period distinct from the readout period of the normal output data.

7. The display device as set forth in claim 1, provided with a display panel at least including said plurality of gate lines, said plurality of source lines, and said compensating line, wherein:
a plurality of the source drivers are arranged along an edge section of the display panel; and
said compensating line is connected only to a plurality of source drivers in a smaller number than a total number of said source drivers sequentially from an endmost source driver among said plurality of arranged source drivers.

8. The display device as set forth in claim 1, provided with a display panel at least including said plurality of gate lines, said plurality of source lines, and said compensating line, wherein:
a plurality of said source drivers are arranged along an edge section of the display panel; and
said compensating line is connected only to a plurality of fewer than all of said source drivers sequentially from an endmost source driver among said plurality of arranged source drivers.

9. The display device as set forth in claim 8, wherein:
said compensating output sections are used sequentially from said endmost source driver among said plurality of arranged source drivers.

10. The display device as set forth in claim 1, wherein each source driver includes:
a plurality of said compensating output sections; and
said compensating lines provided at least in a same number as said plurality of compensating output sections.

11. The display device as set forth in claim 1, wherein:
said compensating line is connected to said burned-out source line having a burned-out point, at an intersection of said compensating line and said plurality of source lines.

12. The display device as set forth in claim 1, provided with a display panel at least including said plurality of gate lines, said plurality of source lines, and said compensating line, wherein said compensating line includes:
(a) a section extending in a direction of crossing said gate line and (b) a section extending in a direction of crossing said source line, which are respectively formed along an edge section of the display panel.

13. The display device as set forth in claim 12, wherein the compensating line includes:
the section extending in the direction of crossing said gate line, arranged so as not to cross said gate line in a gate line non-formed area; and
the section extending in the direction of crossing said source line, arranged so as to cross said source line in the source line termination area.

14. The display device as set forth in claim 12, wherein:
a plurality of said source drivers are arranged along an edge section of the display panel; and
said compensating line is connected only to said compensating output section in an endmost source driver among said plurality of arranged source drivers.

15. The display device as set forth in claim 12, comprising:
a gate driver having a gate substrate omitted structure, which is provided at an edge section of the display panel where said compensating line is not formed.

16. A driving method of a display device, using a display device including (a) a plurality of gate lines and a plurality of source lines arranged in a matrix, and (b) a compensating line provided along a termination section on an opposite side of a signal input terminal section of said plurality of source lines, arranged so as to cross said plurality of source lines where said compensating line is connected to a burned-out source line having a burned-out point, said driving method of the display device, comprising the steps of:
supplying a normal display data signal to respective signal input terminal sections of each of said plurality of source lines; and
supplying a data signal corresponding to said burned-out source line, to said compensating line connected to said burned-out source line, in response to address information for specifying said burned-out source line.
